(19) United States
(12) Patent Application Publication
(10) Pub. No.: US 2022/0036330 A1
(43) Pub. Date: Feb. 3, 2022

(54) Swappable Battery System And Method, Electric Vehicles, Battery As A Service (BaaS)

(71) Applicant: Lyves Hatcher Pte. Ltd., Singapore (SG)

(72) Inventors: Gabriel Zhi Yi Ong, Laguna Niguel, CA (US); Zeming Lim, Singapore (SG)

(21) Appl. No.: 17/389,222

(22) Filed: Jul. 29, 2021

Related U.S. Application Data
(60) Provisional application No. 63/059,070, filed on Jul. 30, 2020.

(51) Int. Cl. G06Q 20/18; G06Q 30/06

(52) U.S. Cl. CPC G06Q 20/18; G06Q 30/0645

(57) ABSTRACT

Embodiments of the present invention broadly disclose electric vehicles (EVs), and a business to business platform including a swappable battery system and method, and systems and methods providing battery as a service (BaaS). In some embodiments a BaaS system and method are provided that create B2B opportunities to drive widespread, economical adoption of EVs.

### RELATED APPLICATIONS

This application claims the benefit of, and priority to, U.S. Provisional Patent Application Ser. No. 63/059,070, filed on Jul. 30, 2020 and entitled “Swappable Battery System and Method, Electric Vehicles, Battery as a Service (BaaS), the full disclosure of which is hereby incorporated in its entirety.

### FIELD

This disclosure is directed generally to electric vehicles, and more particularly to a business to business platform including a swappable battery system and method, providing battery as a service (BaaS).

### BACKGROUND

Motorbikes (typically two or three wheels) are a popular mode of transportation throughout the world, and are the dominate mode of transportation in many countries such as Asia and emerging countries. Currently, motorbikes are typically powered by two stroke internal combustion engines (ICE) which exhibit high emissions and pollution. The usage of ICE motorbikes is so large on a global basis, it is estimated that a reduction in the use of such motorbikes will have a greater impact on reducing carbon footprint and greenhouse gases than reducing the use of four wheel vehicles.

Even while emitting significant pollution, motorbikes are one of the most practical and popular means to navigate in large cities. In many cities throughout Asia and the world, two wheel motorbikes are widely used for delivering food and other items, as well as providing taxi and other transportation services. It is estimated that there are over 500 million active motorbikes worldwide, with over 20 million active motorbikes in Thailand cities alone. And with the advent of the Covid-19 pandemic and the resultant social distancing and quarantine mandates, home delivery of food and other items has become an essential service.

To address the environmental issues and climate change, there is a desire to move away from reliance on fossil based fuels which have led to development of electric powered vehicles (EVs). Electric vehicles provide clear environmental benefits, however EVs have faced slow adoption due in part to perceived unreliability, long charging time, low availability of charging stations, among other factors. Additionally, batteries needed to power the EVs are expensive—the most expensive component of an EV representing about 25% of the cost—making the EV more expensive than a comparable internal combustion engine (ICE) vehicle.

For EVs to meet their full and beneficial potential, new developments and innovative models are needed, particularly technological solutions and business models that create B2B opportunities that will drive widespread, economical adoption of EVs. Accordingly, significant developments are needed to address these problems and limitations.

### SUMMARY

Embodiments of the present invention broadly disclose electric vehicles (EVs), and a business to business platform including a swappable battery system and method, and systems and methods providing battery as a service (BaaS). In some embodiments a BaaS system and method are provided that create B2B opportunities to drive widespread, economical adoption of EVs.

More specifically, embodiments of the invention provide a connected EV ecosystem and infrastructure including a battery swapping network and a user leasing or subscription service app (accessed by users via mobile phones). The battery swapping leasing or subscription network provides many benefits and advantages, for example including without limitation:
Extended use—the BaaS system allows 24/7 use of EV since there is no downtime necessary to recharge the battery;
Greater safety—individual users no longer charge the battery, the battery charging activity is conducted by the BaaS system provider, generally in a centralized, controlled and sheltered environment;
Greater efficiency—batteries can be swapped by a user before the battery is drained and “pay as you use” meaning that the charge to the user for swapping a battery is based on residual battery power, encouraging more efficient battery usage and extended battery life;
Lower cost to the user—batteries can be rented from the BaaS service provider and thus EVs can now be sold without the battery, thereby substantially reducing the purchase cost of an EV and the useful life of the EV since users no longer have to be concerned with the life of the battery; and
Significant environmental benefit—the BaaS system provides a convenient, centralized and cost effective infrastructure which can increase adoption of EVs.
Reduced carbon footprint—the BaaS system may be suitable for use in carbon offset programs and other environmental regulatory programs.
Modularity—embodiments of the BaaS system provide modular kiosks' or battery swapping/charging stations, and as such can be tailored based on demand.
Smart and/or configurable battery packs - embodiments of the BaaS system provide battery packs with connected battery management system (BMS) which enables system providers to locate individual battery packs at all points of time, and to assess real time battery parameters such as the state of charge, state of health, rate of discharge, number cycles, and the like.
Commonality—embodiments of the BaaS system provide a common battery system for multiple service providers, such that infrastructure and networks can be shared by different operators or service providers, thus increasing efficiency, lowering individual costs, and promoting widespread adoption.

In one exemplary embodiment, a BaaS system is provided, generally comprising: (1) one or more batteries or battery packs configured to power an electric vehicle, (2) a battery swapping network comprised of one or more stations or kiosks configured to house charged batteries and swap the charged batteries for used batteries, and (3) a data management system configured to manage the system, including but not limited to functions of tracking the batteries while in use and while housed in the one more kiosk, manage renting, charging and swapping transactions, and manage a mobile application (mobile app) platform where users access the system.

The one or more batteries or battery pack may be configured with a unique identifier that enables tracking of the battery pack though the mobile app and GPS. Additionally, the batteries may include one or more sensors configured to monitor, store and/or transmit desired data such as performance, efficiency, charge, temperature (and other safety data), and the like.

The battery swapping network is comprised of a plurality of stations or kiosks that house one or more batteries where a user can swap a used battery for a charged battery. The kiosks in the network may be fixed or mobile, or a combination of both. Some of the kiosks may simply house the charged and used batteries, and the used batteries are collected and taken to a remote charging facility. Alternatively some of the kiosks, such as a fixed kiosk, may include a co-located power source and provide partial or full charging of the used batteries that are returned by a user.

Mobile kiosks or stations may be configured to route the mobile kiosk to a user with intelligent routing software configured to use battery tracking data to locate users, track remaining life of the onboard battery and route the kiosk close to the users location. Users may also locate available fixed or mobile kiosks using the mobile app. Additional features and embodiments of the present inventions are described in the Detailed Description below and with reference to the Drawings.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram illustrating an overview of a BaaS system according to embodiments of the present invention;

FIG. 2 is a schematic diagram depicting connectivity between a mobile application, the data management system, and a battery pack on an EV, according to exemplary embodiments of the present invention;

FIG. 3 is a flow diagram illustrating a one embodiment of a BaaS transaction system and method according to the present invention;

FIG. 4 is schematic diagram illustrating one embodiment of a BaaS system architecture enabling a subscription or transaction based system and method according to the present invention;

FIG. 5 is a schematic diagram illustrating an example of BaaS system and method with integrated partners, according to additional embodiments of the present invention;

FIG. 6A is schematic diagram illustrating another embodiment of an overview of a battery swapping (BaaS) system according to embodiments of the present invention;

FIG. 6B is a block diagram illustrating system elements of a swapping/charging station or network according to some embodiments of the BaaS system;

FIG. 7 is a flow diagram illustrating one example of a battery pack authentication method used at a kiosk or station according to embodiments of the present invention;

FIG. 8 is flow diagram illustrating one example of a method executed by a mobile application based BaaS transaction according to embodiments of the present invention;

FIG. 9A is a schematic diagram showing systems and information flow between a user, a kiosk or swapping station, and a data or central management system (also referred to as a server) for purposes of locating an appropriate kiosk or station, according to embodiments of the present invention;

FIG. 9B is a is a schematic diagram showing systems and information flow between a user, a kiosk or swapping station, and a data or central management system (also referred to as a server) for purposes of swapping a battery at the kiosk, according to embodiments of the present invention;

FIG. 10 is schematic diagram illustrating one embodiment of a Blockchain architecture used in conjunction with the BaaS system, according to embodiments of the present invention;

FIG. 11 is flow diagram illustrating one example of a method of notifying a user when to swap the users battery pack, according embodiments of the present invention;

FIG. 12A is a flow diagram showing one example of a configurable battery pack allocation method based on a user profile, according to embodiments of the present invention;

FIG. 12B is a flow diagram showing an example of a method of charging a battery based on battery health enabled by the Baas system, according to embodiments of the present invention;

FIGS. 13A and 13B are schematic diagrams illustrating a network of modular kiosks or swapping/charging stations and architecture based on demand;

FIG. 14 is a schematic diagram depicting mobile or on-the-go charging according to some embodiments of the Baas system of the present invention; and

FIG. 15 is a flowchart illustrating two alternative BaaS payment models according to the system and method according to the present invention.

### DETAILED DESCRIPTION

Embodiments of the present invention broadly disclose electric vehicles (EVs), and a business to business platform including a swappable battery system and method, and systems and methods providing battery as a service (BaaS). In some embodiments a BaaS system and method are provided that create B2B opportunities to drive widespread, economical adoption of EVs and provide rental, leasing and/or subscription based models.

Broadly, embodiments of the present invention provide a connected EV ecosystem and infrastructure including a battery swapping network and a user subscription service app (accessed by users via mobile phones). A BaaS system is disclosed herein, generally comprised of: (1) one or more batteries or battery packs configured to power an electric vehicle, (2) a battery swapping network comprised of one or more stations or kiosks configured to house charged batteries and swap the charged batteries for used batteries, and (3) a data management system configured to manage the system, including but not limited to functions of tracking the batteries while in use and while housed in the one more kiosks, manage renting, charging and swapping transactions, and manage a mobile application (mobile app) platform where users access the system.

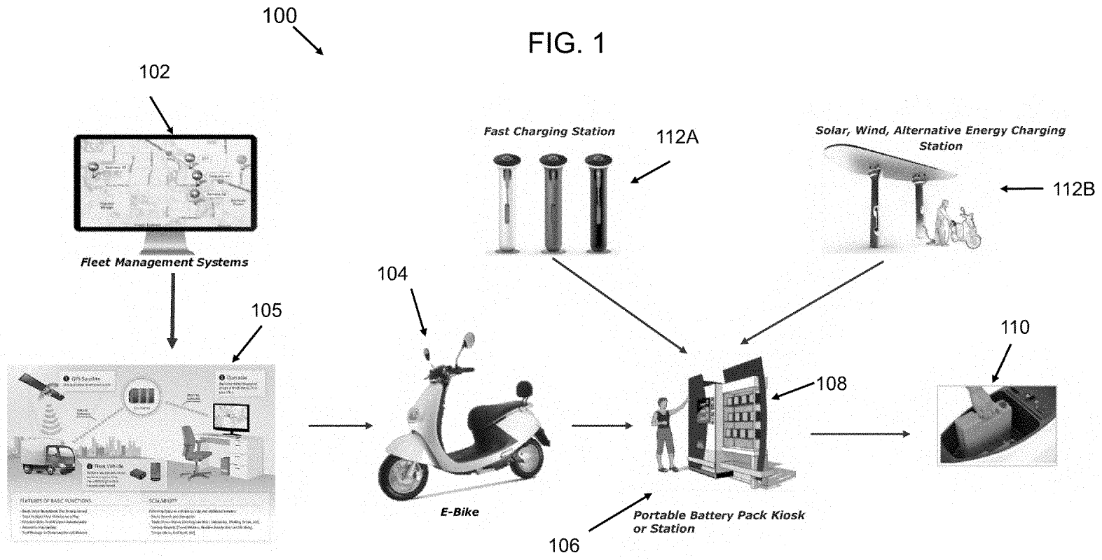

Turning to the figures, FIG. 1 illustrates a schematic overview of the BaaS system 100 according to one embodiment of the present invention. BaaS system 100 generally includes a data management system 102 (sometimes called a fleet management system or central management system; and may be, but not necessarily, implemented by a server) in operable communication, via a cloud based or other suitable wireless communications system 105, with one or more EVs 104 and a battery swapping network 106 comprised of one or more battery kiosks or stations 108. The battery kiosks 108 provide access to one or more batteries or battery packs 110 for use in powering the EVs 104.

The battery swapping network 106 is typically comprised of a plurality of battery kiosks 108. The individual kiosks 108 in the network 106 may be mobile or portable, or fixed, or a combination of both mobile and fixed. Typically each kiosk will include some amount of on-board power to maintain the charge of the battery packs housed in the kiosk and waiting to be swapped and used by a user. Alternatively, a kiosk may include robust charging capability in order to provide full charging of returned batteries. In such instance, the kiosk is coupled to a charging station 112, such as fast charging station 112A or an alternative energy charging station 112B.

For purposes of this description, battery packs that have been used to power an EV and are being returned to a kiosk are referred to as “used battery pack(s)” or “used battery(ies)”. It is to be understood that a used battery pack does not necessarily mean that the battery is drained or has consumed a specified or predetermined amount of charge, the term “used” in this context simply means that a battery has been in the possession of a user and is being returned to a kiosk.

Typically, when a user returns a used battery to the kiosk, the user will swap the used battery for a new battery. For purposes of this description, battery packs that are housed in a kiosk and provided to a user for use in powering an EV are referred to as “new battery pack(s)” or “new battery(ies)”. It is to be understood that a new battery pack will typically be fully charged when provided to a user, but not necessarily so. One advantage of the system and method of the present invention is the flexibility of the system and in some instances a user may wish to swap a used battery for a new battery that is not fully charged based on a users' need.

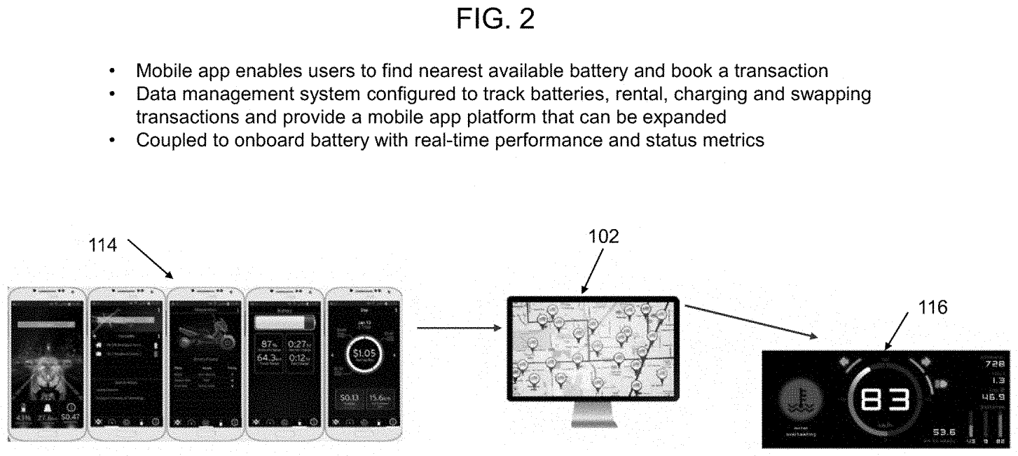

A user may access the system and method by a variety of means. In one example, as illustrated in FIG. 2, the user may download a mobile application (app) 114 to the users' smart phone. The mobile app 114 contains software configured to enable the user to find the nearest available battery kiosk based on the users' current location and to book a transaction. The mobile app accesses the data management system 102, which is wirelessly coupled to the kiosks and optionally may be wirelessly coupled to the batteries 116 onboard an EV in order to convey real-time performance and status metrics to the data management system 102. The data management system 102 is comprised of one or more special purpose computer devices and is configured to track the batteries, rental transactions, charging activity and swapping transactions, and provides the mobile app platform which can be expanded to meet user demand.

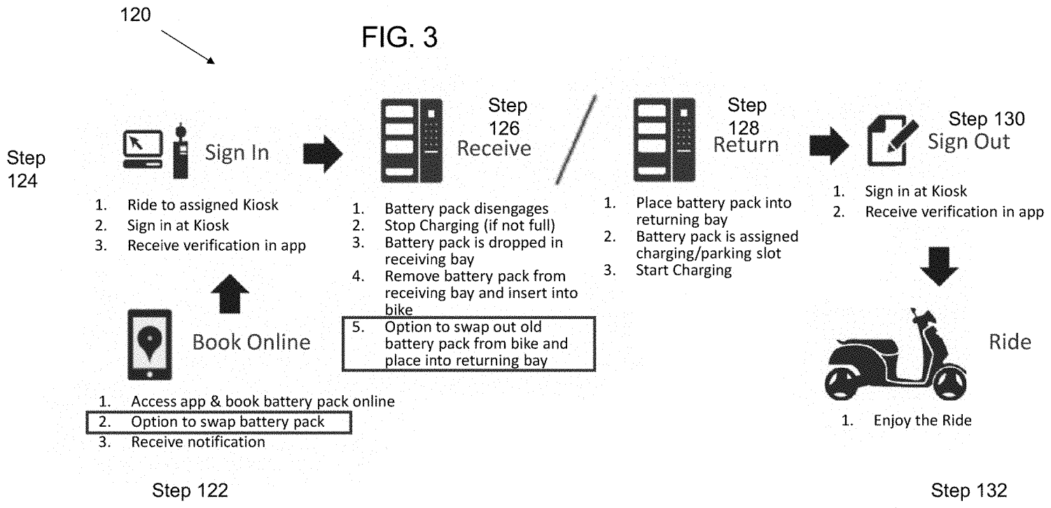

FIG. 3 illustrates one example of a method 120 utilized by a user to initiate and execute a transaction on the BaaS platform. In the exemplary embodiment, a user initiates a transaction at step 122. The user accesses the mobile app and initiates an online booking managed by the data management system 102. The mobile app, directed by the data management system, prompts the user with an option to swap a battery pack and based on the users' input, a notification is sent to the user. The notification provides relevant information to the user, such as without limitation, confirmation of the users' request, assignment of a kiosk to the user for consummating the transaction, instructions and location of the kiosk, and the like.

Next, the user travels to the assigned kiosk. The mobile app may include GPS or other location services to provide the user with directions to the location of the assigned kiosk. Once the user arrives at the assigned kiosk, the user signs in (step 124). The user initiates sign in by any suitable means, such as scanning a notification code, entering a name, or providing a verification code provided to the user through the mobile app.

At step 126, the data management system 102 verifies or authenticates the sign in, and executes a receive transaction. Specifically, the data management system directs the kiosk to disengage a battery pack from the kiosk, which stops charging of the battery pack (if not full). The battery pack is dropped into a receiving bay. The user retrieves the new battery pack from the receiving bay and inserts the battery pack into an EV. The user may also be prompted with the option to swap out the old battery pack from the EV and return the old battery pack to a return bay in the kiosk.

If the user opts to swap out the old battery pack from the EV and return it to the kiosk, the data management system executes a return transaction at step 128. The user places the old battery pack into a return bay in the kiosk. The battery pack is assigned a charging or parking slot in the kiosk and is mechanically transferred to its assigned slot at which point charging of the battery is initiated.

Once the receive transaction and optionally the return transaction are complete, the user signs out at the kiosk at step 130. A receipt and verification is sent to the user via the mobile app with information regarding the transactions. Preferably, payment is made through the mobile app. Alternatively, payment made be made directly at the kiosk using a credit card or other electronic payment system, token, or the like. After payment and sign out are complete, the user rides off on the EV (step 132).

In some embodiments, the BaaS system and method provides a “pay as you go” feature. In this embodiment, a user pays only for the amount of battery charge he/she has used at the time the user swaps the used battery at a kiosk for a new battery. Of particular advantage, this feature provides significant flexibility and utility for users, thereby lowering barriers of entry and cost for EVs.

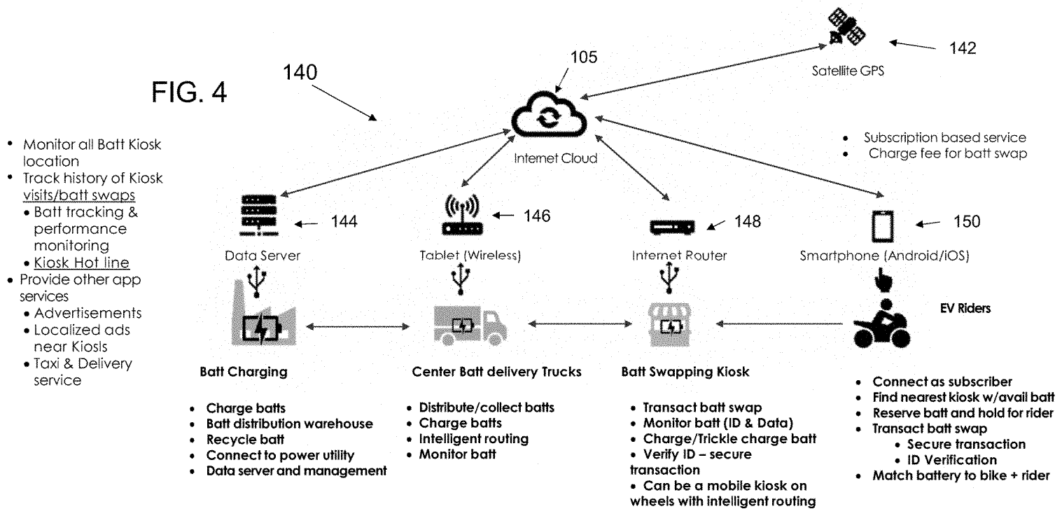

FIG. 4 illustrates one embodiment of a BaaS system network architecture 140 enabling a subscription or transaction based system and method according to the present invention. The disclosed methods and systems herein may be implemented as computer programs or application software on one or more computing devices that process user features and activity collected by an electronic payment system. While the BaaS system is configured as a Software as a Service (SaaS) system, other configurations are also contemplated such as a Platform as a Service (PaaS) system, an Infrastructures as a Service (IaaS) system, or other similar on-demand software systems such as subscription-based models, and the like.

Embodiments described herein are configured to perform battery charging, locate available batteries for users, facilitate battery swapping, verification of users and payment transactions within a special purpose hardware platform to manage such activities and facilitate transactions and payment.

Turning again to FIG. 4, the exemplary system 140 includes a network 105, a first terminal device associated with management of charging of batteries (referred to herein as “battery charging terminal device 144”), a second terminal device associated with central management of battery delivery (referred to herein as “battery delivery terminal device 146”), a third terminal device associated with management of the battery swapping kiosks (referred to herein as “battery swapping kiosks terminal device 148”) and user devices 150. The network 105 may also include satellite GPS 142.

The network 105 is preferably hosted in cloud and includes the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one LAN to another. Furthermore, remote computers and other related electronic devices could be remotely connected to either LANs or WANs via a modem and temporary telephone link. Network 105 includes any communication method by which information may travel between computing devices.

Generally, the network 105 performs all functions of the BaaS system including without limitation monitoring all battery kiosks, their location, status of batteries at each kiosk. The network 105 tracks the history of transactions at each kiosk, number of visits and battery swaps. The network monitors and tracks each battery, its level of charge and performance. The network may also provide other app services such as advertisements, localized ads near kiosks, taxi and delivery services, driving directions and map services, and the like.

The terminal devices 144-150 may include virtually any computing device that typically connects using a wired or wireless communications medium such as personal computers, multiprocessor systems, data servers, routers, tablets, microprocessor-based or programmable consumer electronics, network PCs, smartphones, and the like. The user device 150 may further be configured to include a client application that enables a user to log into a user account that may be managed by the service provider.

In the exemplary embodiment, battery charging terminal device 144 is comprised of a data server associated with management of charging of batteries. Battery charging terminal device 144 typically further provides management of battery distribution warehouses, recycling of batteries and providing connections to power utilities for battery charging operations.

Battery delivery terminal device 146 provides central management of battery delivery and may be comprised of one or more wireless tablet devices carried by battery delivery trucks that distribute and collect batteries are directed by the network. Intelligent routing may be used to enhance efficiency and speed of delivery.

Battery swapping kiosk terminal device 148 provides management of all the battery swapping kiosks in the network via internet routers, and is configured to facilitate the battery swapping transaction (both receive and return transactions), monitor the battery packs (identification and data), optionally provide charging of batteries or trickle charging at the kiosk and verify and conduct secure transactions. The kiosks can be mobile and configured to move on wheels with intelligent routing to move the kiosks closer to user location and to serve locations of high user demand, such as train stations, retail, financial or employment hubs, and the like. (referred to herein as “battery swapping kiosks terminal device 148”) and user devices 150. The network 105 may also include satellite GPS 142.

User device(s) 150 are typically a smartphone carried by the user with the mobile app to connect the user to the network as a subscriber. Many function can be executed via the user device 150 such as signing in to the network and initiating a transaction, finding the kiosk nearest to the user with an available battery pack, reserving the battery for the user, in addition to facilitating conduct of a secure transaction and proving identification and verification.

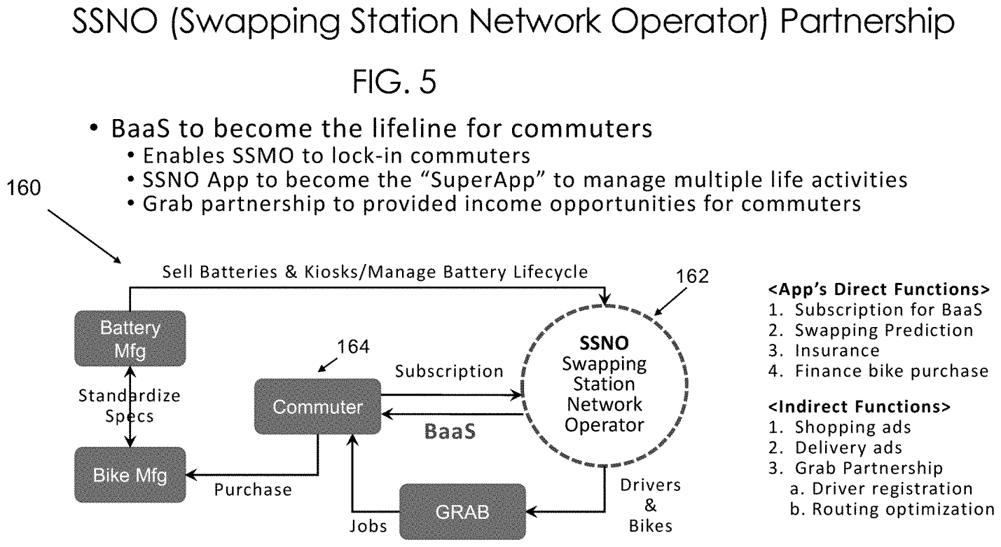

It is noted that while embodiments herein are described with reference to BaaS provider 160 and users, where the users are different from the service provider, other intermediate entities may also benefit from the principles disclosed herein as shown in FIG. 5. For example, a swapping station network operator (SSNO) 162 is provided, which may, in partnership with other entities, provide a hub for managing multiple life activities of users, particularly commuters 164. Embodiments disclosed herein may be applied to create partnerships with associated and/or interested business such as battery manufacturing, EV manufacturers, insurance companies, banking industries, Gig economy companies and platforms, retailers, utilities, government agencies, or virtually any other industry with an interest or association with transportation or energy consumption. In one embodiment, the battery swapping kiosks and system disclosed herein may be located at traditional gasoline stations, where users swap used batteries for charged batteries for powering their EV's, similar to how drivers fill their ICE vehicles with fuel/gasoline to power their ICE vehicles (e.g. cars, buses, trucks, etc.).

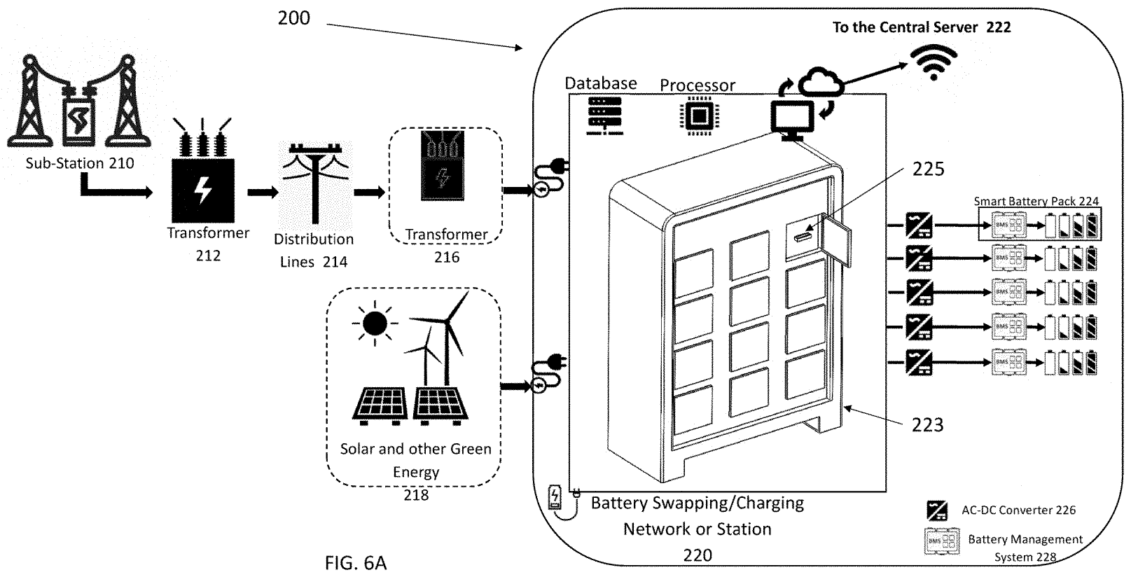

Another embodiment of the battery swapping system (BaaS system) and method is illustrated in FIGS. 6A and 6B, showing a schematic overview of the BaaS system 200. BaaS system 200 generally includes a battery swapping network 220 swapping/charging station or network 220 in operable communication with a central server 222. Note that the battery swapping network 220 is also sometimes referred to herein as swapping/charging station, kiosk or network, and as described in the context this description perform the same or similar functions.

The swapping/charging network 220 includes one or more databases and a local controller or processor. The swapping/charging network 220 further includes one or more kiosks or stations 223 configured to house a plurality of battery packs 224. In one embodiment, kiosk or station 223 is configured as a cabinet containing multiple lockers 225, each configured to house a battery. In some embodiments, each locker 225 includes an associated AC-DC converter 226 for charging of the battery pack 224. In some embodiments, the battery packs 224 are configured with a battery management system 228, thereby providing a smart or connected battery pack.

The central server 222 (also sometimes referred to and shown herein as central management system (CMS)) is preferably hosted in the cloud and may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one LAN to another. Furthermore, remote computers and other related electronic devices could be remotely connected to either LANs or WANs via a modem and temporary telephone link. Central server 222 includes any communication method by which information may travel between computing devices.

The individual stations or kiosks 223 in the swapping/charging station or network 220 may be mobile or portable, or fixed, or a combination of both mobile and fixed. Typically each station or kiosk will include some amount of on-board power to maintain the charge of the battery packs housed in the station or kiosk and waiting to be swapped and used by a user. The swapping/charging network or station 220 may include robust charging capability in order to provide full charging of returned batteries. In such instance, the swapping/charging network or station 220 may be coupled to one or more energy sources, such as but not limited to a traditional sub-station system 210, 212, 214, 216; or alternatively coupled to a green energy source 218 such as solar and the like.

FIG. 6B is another illustration of the Baas System according to some embodiments, and generally comprises a user interface system 205, swapping/charging network or station 220, and cloud based central server or central management system 222. User interface system 205 may be any suitable interface and may contains control and audio functions, QR code enabled and one or more displays. In one example the user interface is accessed via a mobile application on a user's smart or handheld phone as described in detail below. In this example the swapping/charging station 220 generally includes main processor 207, charging system 209 and cabinet 211 containing multiple lockers, each locker configured to house a battery. The main processor 207 is generally comprised of RAM and ROM memory, a controller and communication module for communication with the central server 222. The charging system 209 is comprised of elements for charging the battery packs and generally includes rectifiers, AC-DC converters, power electronics, filters, relays and switches.

It is to be understood that the computing and computer elements described above and herein may be implemented on any electronic device that runs software applications derived from compiled instructions, including without limitation personal computers, servers, smart phones, media players, electronic tablets, game consoles, email devices, etc. In some implementations, the computing elements may include one or more processors, one or more input devices, one or more display devices, one or more network interfaces, and one or more computer-readable media. Each of these components may be coupled by a bus. As used herein display devices may be any known display technology, including but not limited to display devices using Liquid Crystal Display (LCD) or Light Emitting Diode (LED) technology. Processors may use any known processor technology, including but not limited to graphics processors and multi-core processors. Input devices may be any known input device technology, including but not limited to a keyboard (including a virtual keyboard), mouse, track ball, and touch-sensitive pad or display. Bus may be any known internal or external bus technology, including but not limited to ISA, EISA, PCI, PCI Express, USB, Serial ATA or FireWire. Computer-readable medium may be any medium that participates in providing instructions to processor(s) for execution, including without limitation, non-volatile storage media (e.g., optical disks, magnetic disks, flash drives, and the like.), or volatile media (e.g., SDRAM, ROM, and the like.).

Computer-readable medium may include various instructions for implementing an operating system (e.g., Mac OS®, Windows®, Linux and the like). The operating system may be multi-user, multiprocessing, multitasking, multithreading, real-time, and the like. The operating system may perform basic tasks, including but not limited to: recognizing input from input devices; sending output to display devices; keeping track of files and directories on computer-readable medium; controlling any peripheral devices (e.g., disk drives, printers, and the like) which can be controlled directly or through an I/O controller; and managing traffic on bus. Network communications instructions may establish and maintain network connections (e.g., software for implementing communication protocols, such as TCP/IP, HTTP, Ethernet, telephony, and the like.).

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java and the like), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

Features may be implemented in a computer system that includes a backend component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

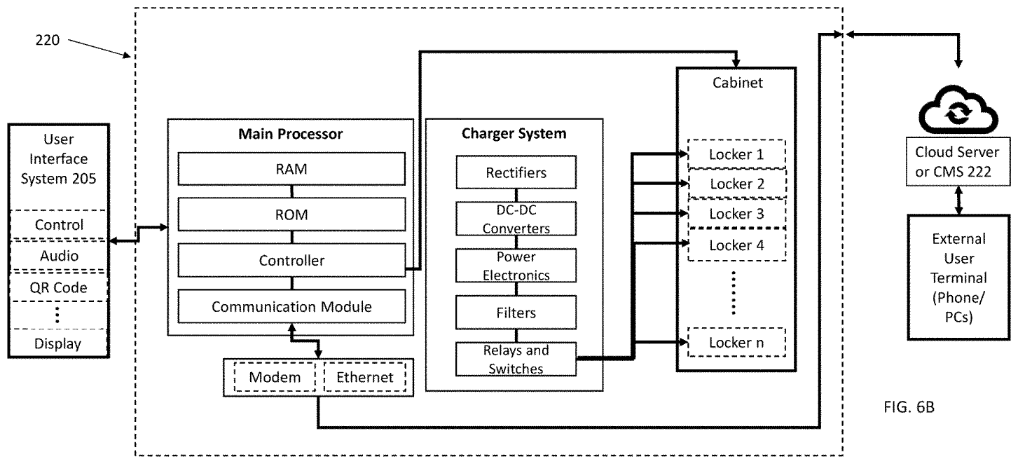

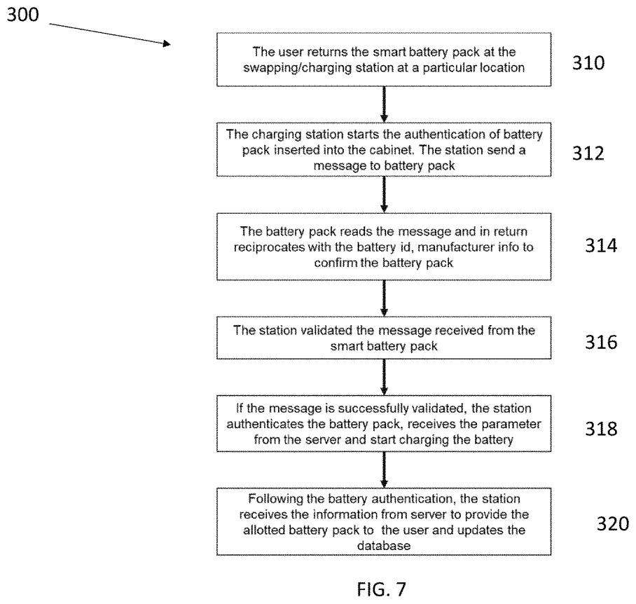

When a user wishes to return or remove a battery from the swapping/charging station 220, a battery authentication process 300 is implemented as illustrated in FIG. 7. First, at step 310 the user returns a battery pack 224 to a particular location in the cabinet, such a particular locker 225. Next, the swapping/charging station 220 begins authentication of the battery pack inserted into the cabinet and sends a message to the battery pack 224 at step 312. At step 314 the battery pack reads the message from the swapping/charging station and in return the batter pack sends identifying information back to the swapping/charging station to confirm the authenticity of the battery pack. Identifying information may include, without limitation: battery ID, manufacturer, make and model, serial number, and the like. Once received, the swapping/charging station 220 validates the message received from the battery pack at step 316.

If the message from the battery pack is successfully validated, the swapping/charging station 220 authenticates the battery pack, and communicates with the central server 222 and receives parameters from the central server 222 to charge the battery pack at step 318. Lastly, following the above steps, the swapping/charging station 220 receives information from the central server 222 directing the allocated battery pack to the user and updates the database at step 320.

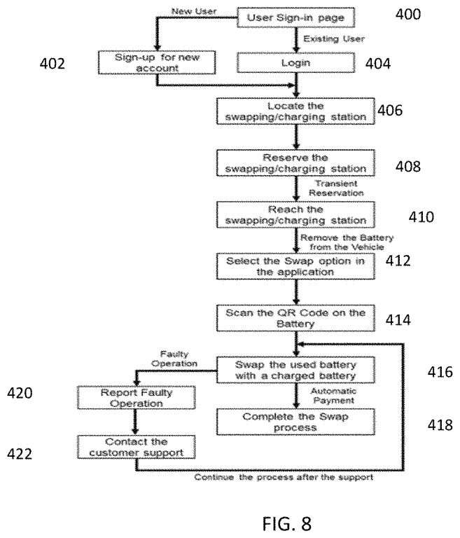

Typically, users will access and interface with the BaaS system by using a mobile application (sometimes referred to as an app). FIG. 8 shows one example of a method executed by a mobile application based BaaS transaction according to embodiments of the present invention. First, a user accesses a user sign in page (step 400). If the user is new, the user is directed to sign up for a new account (step 402). If the user is an existing user, the user is directed to login (step 404). Once the new or existing user has logged in, the app locates a swapping/charging station (step 406). The location can be suggested by the app to the user based on GPS used to identify the location of the user and the closest swapping/charging station. Alternatively, the user can select a particular station.

Next, the swapping/charging station is reserved and identified as a transient reservation (step 408). Once the user reaches the station (step 410) the user removes the used battery from the vehicle. Next, the user selects the “swap” option in the app (step 412) and scans a QR code (or other similar identifier) on the used battery (step 414). The user may now swap the used battery with a new, charged battery (step 416). An automatic payment transaction is executed and the swap process is complete (step 418). In the event the new charged battery is faulty, the user can report the faulty operation in the app (step 420) which will put the user in contact with customer support (step 422).

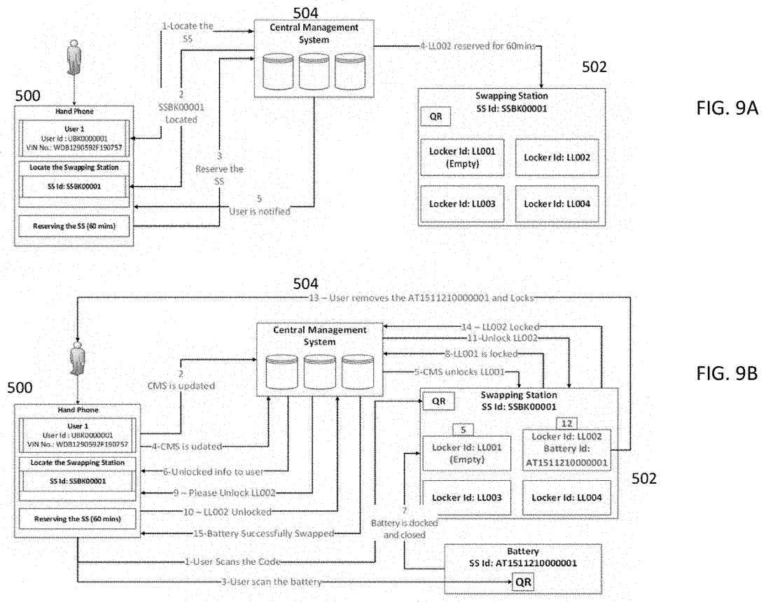

Turning to FIG. 9A and 9B, system diagrams are shown according to one embodiment of the present invention. The disclosed methods and system may be implemented as computer programs or application software on one or more computing devices that process user features collected and directed by the central management system Devices and networks described herein can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one LAN to another. Furthermore, remote computers and other related electronic devices could be remotely connected to either LANs or WANs via a modem and temporary telephone link. Networks includes any communication method by which information may travel between computing devices.

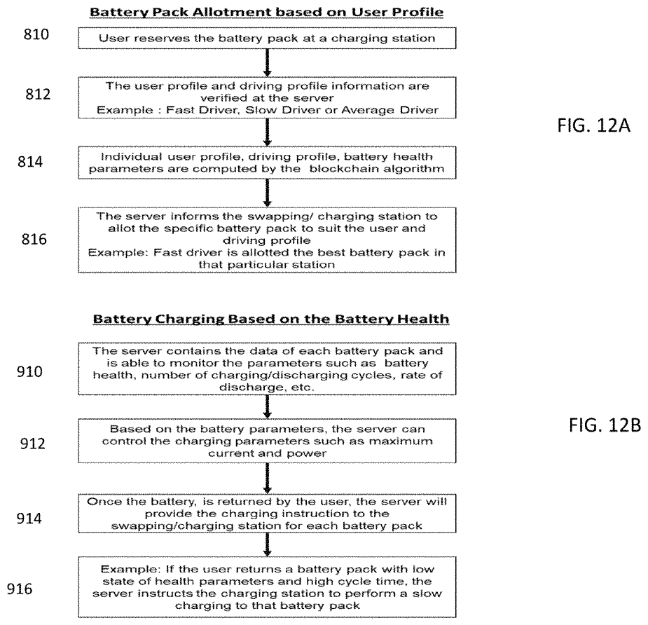

FIG. 9A illustrates various system elements and data flow between a user device 500, swapping/charging station 502, and a data or central management system (CMS) 504 (also sometimes referred to as the central server 222 as shown in FIG. 5) as implemented by the battery swapping (BaaS) system configured to carry out instructions for the function of locating an appropriate swapping/charging station or kiosk. The user device 500 is typically a handheld or cell phone; however user device 500 may include virtually any computing device that typically connects using a wired or wireless communications medium such as telephones, televisions, video recorders, cable boxes, gaming consoles, personal computers, multiprocessor systems, microprocessor-based or programmable consumer electronics, network PCs, or the like. The user device 500 is typically configured to include a mobile application (such as described above and illustrated in FIG. 8) that enables the user to log into a user account that may be managed by the service provider. Information provided either as part of user account generation, user account utilization, and or other activity may result in providing various user profile information. Such user profile information may include, but is not limited to, type of user and/or behavioral information about the user, particularly the user's driving profile and driving habits (as shown in FIG. 12A and described below).

Referring again to FIG. 9A, user device 500 includes a user ID and Vin no. and communicates with the central management system 504 and executed the following steps: (1) inquiry is sent by user to locate a swapping/charging station, (2) a particular swapping/charging station with a unique ID (SS Id) is located and communicated by the central management system, (3) the particular swapping/charging station is reserved for a certain period of time, (4) the central management system identifies an open locker LL001 and notifies the particular swapping/charging station to reserve the locker for the certain time period; and (5) the user is notified of confirmation of the reservation.

FIG. 9B illustrates various system elements and data flow between a user device 500, swapping/charging station 502, and a data or central management system 504 as implemented by the BaaS system configured to carry out instructions for the function of swapping of a battery at the swapping/charging station or kiosk. When the user arrives at the designed swapping/charging station 502, the following steps are executed: (1) the user scans the QR code at the swapping/charging station and (2) the central management system is updated, (3) the user scans the QR code on the used battery to be swapped and (4) the central management system is updated, (5) the central management system unlocks the reserved locker LL001 and (6) notifies the user of the unlocked locker information, (7) the user places the used battery in locker LL001, the used battery is docked and the locker is closed, (8) the swapping/charging station notifies the central management system that the locker LL001 is now locked, (9) next the central management system identifies a charged battery (also referred to as a new battery) to be provided to the user and instructs the user to open locker LL002 to retrieve the charged battery, (10) the user selects the unlock feature on the app and (11) the central management system sends instructions unlock locker LL002, (12) locker LL002 houses a charged battery with an unique battery identification number, (13) the user removes the charged battery, (14) locker LL002 is locked and (15) the user is notified that the battery has been successfully swapped.

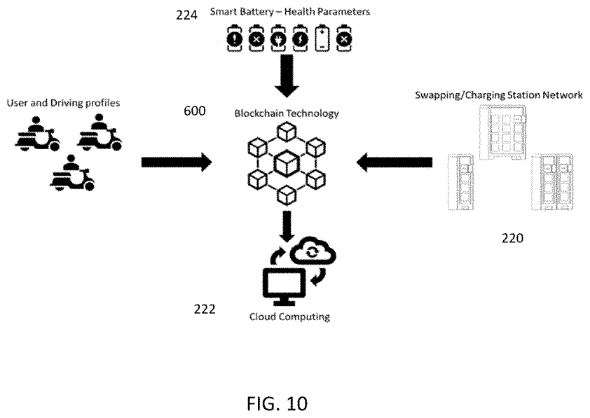

Of particular advantage, embodiments of the BaaS system and method provide personalized, configurable battery swapping services. More specifically, in some embodiments the BaaS system and method employs smart battery packs 224. The smart battery pack 224 is built with a battery management system 228 which is configured to communicate with the central server 222 (FIG. 5) or central management system 504 as the case may be. The BaaS system with smart battery packs enables service providers to locate individual battery packs at any or all points of time, and to access and analyze real time battery operation and parameters such as the state of charge, state of health, rate of discharge, number of cycles, and the like. The smart battery pack communicates with the sever by any suitable wireless communications medium or technology, such as for example using low energy Bluetooth. In this embodiment, the smart battery pack is always connected and continuously shares data with the central management system or server through the user handphone. In some embodiments, blockchain technology 600 may be used to receive and analyze such data, as illustrated generally in FIG. 10.

In some embodiments, the BaaS system and method provides real time battery analysis that enables monitoring and control or optimization of battery usage. This feature may also provide personalization or optimization for users based on individual driving habits and user profiles. For example, in one embodiment, the central server or central management system receives information from the smart battery packs. This information can be data regarding identity of each smart battery pack, the operating and performance of each battery pack, and the driving pattern of every user associated with the smart battery pack at any or more points of time. Information regarding the driving pattern of a user may include, but is not limited to: driving speed, acceleration, duration of trips, distance, and the like.

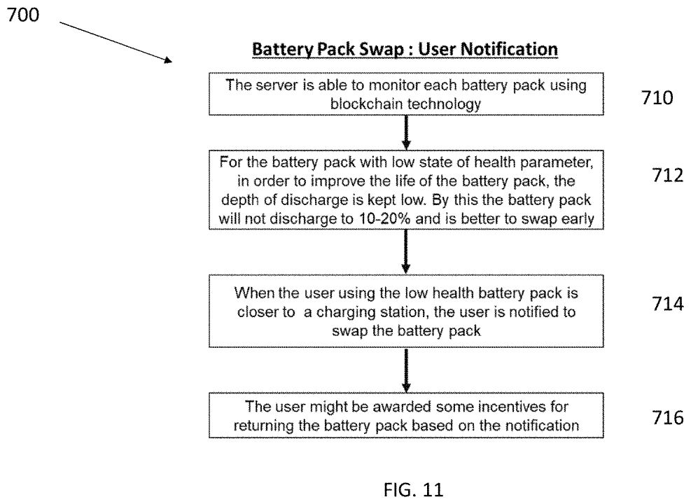

FIGS. 11-12B illustrate methods employed by the BaaS system to implement real time battery analysis, control and optimization of the battery swapping system and service described herein. The methods are typically implemented by one or more algorithms executed by programs, to perform the functions described in the figures. As mentioned above, based on the health of battery, state of charge, life cycle and the like, the inventive BaaS system can control the charging and discharging pattern of each battery pack. Further, based on the user driving profiles, the inventive BaaS system can define and execute the discharging pattern of a battery pack while used by that particular driver, in order to improve the overall life of the battery pack or achieve other service provider objectives. Additionally, the central server or central management system can instruct a swapping/charging station to regulate the charging rate based on the state of each battery pack. Optionally, the central server or central management system may implement changes to the battery management system 228 of a smart battery pack 224 at the swapping/charging station responsive to the user driving profile of the particular user that is to receive the new smart battery pack.

Turning to FIG. 11, one example of a method 700 of notifying a user when to swap the users' battery pack is shown. The central server or central management system monitors each smart battery pack while in operation and assigned to a user at step 710. The method of monitoring the smart battery pack may be implement by any suitable software/hardware systems or methods, including but not limited to blockchain. At step 712, the central server or management system identifies any smart battery pack that falls below certain defined thresholds. A service provider may set or define any threshold as desired; for example but not limited to health parameters associated with battery life or performance, and then set a low state of such parameter as a threshold. The central server or management system may then control operation of the battery pack, responsive to the battery pack's current state, to improve the life of the battery pack. In one exemplary embodiment, for a battery pack exhibiting a low state of health parameter as compared to a defined threshold, the central server may control the depth of discharge of the battery pack to be kept low, such as for example limiting the battery pack operation so that the battery no longer discharges once it reaches a certain charge level, capacity or operating life such as 10-20%. In this instance, the user is notified to swap the battery pack at step 714. In some embodiments, the central server may send notification to the user to swap the battery pack when the user comes within a defined distance of a swapping/charging station. Optionally, the service provided may offer or award an incentive to the user at step 716 for returning the battery pack in response to the notification.

In some embodiments, the Baas system and method provides configurable or personalized assignment or allotment of battery packs to users based on a user's unique profile. FIG. 12A shows one example of a configurable battery pack allocation or assignment method 800 based on a user profile. Using the methods described above (for example shown in FIGS. 7 and 9A), a user reserves a new battery pack at a swapping/charging station at step 810. The user profile and user driving profile information are identified and verified by the central management system at step 812. In one example, the user driving profile is identified as “fast driver”, “slow driver” or “average driver” and is based on the real time operation and performance data output from the smart battery packs in prior use by the user and stored and analyzed by the central management system or server for that user (step 814). Based on this analysis, central management system selects a specific battery pack and direct the swapping/charging station to allocate or assign that specific battery pack to the user at step 816.

Additionally, the Baas system and method may be configured to direct the charging of old or swapped batteries based on the current state of health of that particular battery, and thus may prolong battery life. FIG. 12B shows one example of a method 900 of charging a battery based on battery health enabled by the Baas system. The central management system or server stores data pertaining to each battery pack and monitors defined parameters at step 910, such as but not limited to battery health, number of charging and discharging cycles, rate of discharge and the like. Based on the parameters in step 910, the central management system is configured to control charging parameters during the charging operation of individual battery packs carried out at the swapping/charging station at step 912. Charging parameters may be defined by the service provider and include, but are not limited to, maximum current and/or power. In this embodiment, when a user returns a battery pack to the swapping/charging station, the central management system will send charging instructions to the swapping/charging station to charge the battery pack using the particular charging parameters at step 914. In one example, if a user returns a battery pack with a low state of battery health and high cycle time, the central management system instructs the swapping/charging station to perform slow charging of that battery pack (step 916).

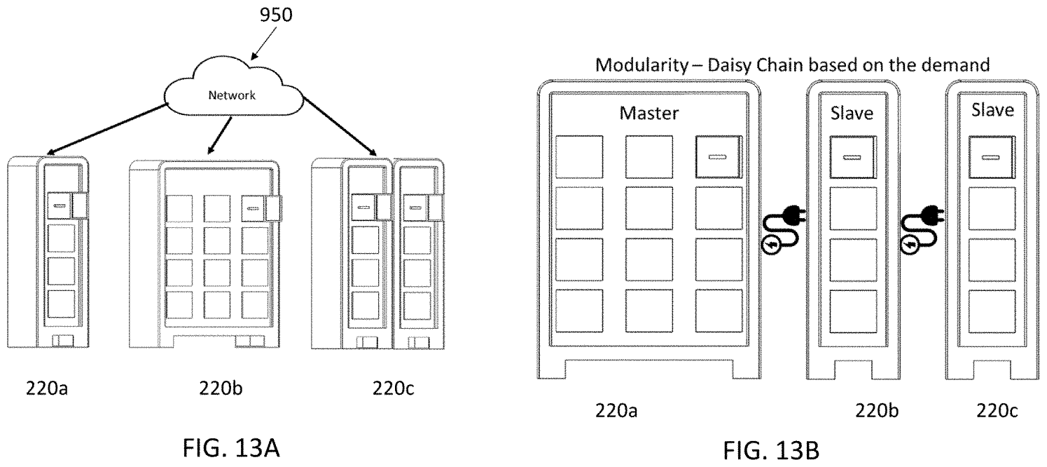

In some embodiments, the BaaS system and method provides modular kiosks or swapping/charging stations, and as such enables tailoring the BaaS system based on user demand. FIGS. 13A and 13B illustrate a network of modular swapping/charging stations or kiosks. In one example, multiple swapping/charging stations 220 are connected via network 950. Capacity may be increased by adding additional swapping/charging station modules or kiosks 220a, 220b, 220c, that are configured to be daisy chained to increase the capacity of the overall system. When using a daisy chain configuration, the plurality of stations are configured as master and slave stations for implementing communication and control features of the system.

Additionally, the modular charging stations can be relocated to support more battery swaps in response to increased demand. For example when demand at a particular location is high, or when there is little demand at a particular location, the modular swapping/charging stations can be moved from one location to the other to meet demand.

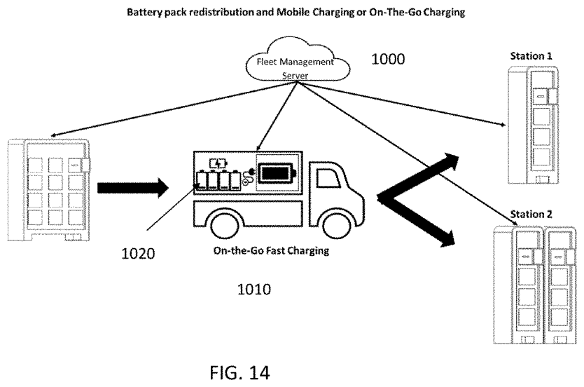

In another aspect, to meet increased or localized user demand such as during high commute periods, the Baas system and method may be configured to provide mobile charging and/or on-the-go charging. Referring to FIG. 14, mobile or on-the-go charging is illustrated according to some embodiments. When battery pack demand surges in different locations, battery packs are redistributed by a fleet management system 1000. In one example, the fleet management system 1000 is in communication with and controlled by the central management system 222. The fleet management system 1000 is in communication with one or more mobile vehicles 1010 that contain on board high capacity battery packs 1020. These on board high capacity battery packs 1020 provide mobile fast charging and act as on-the-go-chargers (OTG).

When a surge in demand occurs at one location, the fleet management system 1000 instructs one of more of the mobile vehicles 1010 to retrieve one or more battery packs from one location (Station 1) and to redistribute the retrieved battery pack(s) to one or more other stations (Station 2). While the battery packs are being redistributed, the mobile vehicle is capable of providing rapid charging of the battery pack(s) if desired. The mobile vehicle may be configured to rapid charge the battery pack(s) up to a defined value, for example up to 70%. Thus, when the battery packs are delivered to Station 2 they are ready for users to swap, thereby increasing service quality provided to the users; and

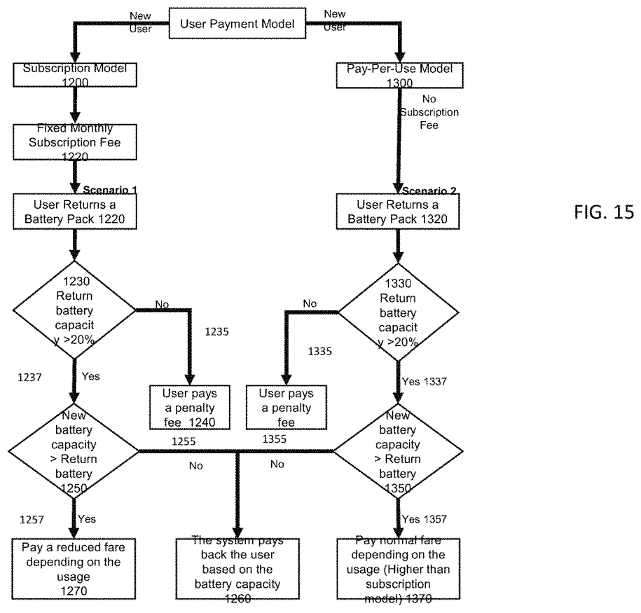

The BaaS system and method is configurable for multiple payment models, thereby providing flexibility to service providers. FIG. 15 is a flowchart illustrating an example of two alternative BaaS payment models, a subscription payment model 1200 and a pay-per user payment model 1300.

In one example, under the subscription payment model 1200, a new user pays a fixed monthly subscription fee at step 1210 for access and use of the BaaS system and service. Under this scenario 1, when the user returns a battery pack to a swapping/charging station (step 1220) the system determines whether the capacity of the returned battery (battery A) is above a defined threshold at step 1230, in this non-limiting example the defined threshold is greater than 20% remaining capacity. If the determination at step 1230 is no (line 1235), the user pays a fee at step 1240. If the determination at step 1230 is yes (line 1237), then the system next determines whether a new battery (battery B) capacity is greater than battery A at step 1250. If the determination in step 1250 is no (line 1255) then the system pays back the user at step 1260 based on some defined measure, such as but not limited to battery B capacity, or the difference between battery A and battery B capacity, or other basis.

If the determination at step 1250 is yes (line 1257) then a reduced fare is calculated at step 1270. The reduced fare may be based on any factor, for example the reduced fare may be based on usage of battery A, or the difference in capacity between batter A and battery B.

The pay-per-use model is shown starting at step 1300. In one example, under the per-per-use model, a user does not pay a fee to access the BaaS system and service. Under this scenario 2, when the user returns a battery pack to a swapping/charging station (step 1320) the system determines whether the capacity of the returned battery (battery A2) is above a defined threshold at step 1330, in this non-limiting example the defined threshold is greater than 20% remaining capacity. If the determination at step 1330 is no (line 1335), the user pays a fee at step 1340. If the determination at step 1330 is yes (line 1337), then the system next determines whether a new battery (battery B2) capacity is greater than battery A2 at step 1350. If the determination in step 1350 is no (line 1355) then the system pays back the user at step 1260 based on some defined measure, such as but not limited to battery B capacity, or the difference between battery A2 and battery B2 capacity, or other basis.

If the determination at step 1350 is yes (line 1357) then a normal fare is paid at step 1370, the normal fare being calculated based on usage. This normal fare will typically be higher than the fare paid under the subscription model based on the same usage. While specific examples, such as threshold, fees and fares are described herein, alternative means of payment may be utilized and the invention is not limited to any one form of value or monetary consideration.

It will be understood that each block of the processes, and combinations of blocks in the processes discussed above, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multiprocessor computer system. In addition, one or more blocks or combinations of blocks in the illustration may also be performed concurrently with other blocks or combinations of blocks, or even in a different sequence than illustrated without departing from the scope or spirit of the subject innovation. Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware-based systems, which perform the specified actions or steps, or combinations of special purpose hardware and computer instructions.

It is to be expressly understood that the embodiments shown herein are illustrative only and should not be viewed as limiting the scope of the embodiments by which this disclosure can be implemented. Those skilled in the art, to whom this disclosure is directed, will, upon reading this disclosure, envision modification to the disclosed embodiments and other embodiments not expressly disclosed, without the exercise of their own invention.

We claim:

1. A battery swapping system, comprising:
one or more batteries or battery packs configured to power an electric vehicle;
a battery swapping network comprised of one or more stations or kiosks configured to house charged batteries and swap the charged batteries for used batteries; and
a data management system configured to manage the battery swapping system, including but not limited to functions of tracking the batteries while in use and while housed in the one more kiosk, manage renting, charging and swapping transactions, and manage a mobile application (mobile app) platform where users access the system.

2. The battery swapping system of claim 1 wherein the one or more batteries or battery pack is configured with a unique identifier that enables tracking of the battery pack through the mobile app and a GPS network.

3. The battery swapping system of claim 2 wherein the batteries include one or more sensors configured to monitor, store and/or transmit battery data, including performance, efficiency, charge, temperature.

4. The battery swapping system of claim 1 wherein the battery swapping network is comprised of a plurality of stations or kiosks that house one or more batteries where a user can swap a used battery for a new charged battery.

5. The battery swapping system of claim 4 wherein the plurality of stations or kiosks are fixed or mobile, or a combination of both.

6. The battery swapping system of claim 4 wherein one or more of the plurality of stations or kiosks are include a co-located power source and provide partial or full charging of used batteries that are returned by a user.

7. The battery swapping system of claim 4 wherein one or more of the plurality of kiosks include mobile kiosks, said mobile kiosks being configured with intelligent routing software to route the mobile kiosk to a user.

8. The battery swapping system of claim 7 wherein the mobile kiosks are further configured to use battery tracking data to locate users, track remaining life of the onboard battery and route the kiosk close to the users location.

9. The battery swapping system of claim 1, wherein the a data management system is comprised of a network, the network comprising multiple terminal devices in communication with network, and including a battery charging terminal device, a battery delivery terminal device, a battery swapping kiosks terminal device, and one or more user devices.

10. A computer implemented method for providing a battery swapping service (BaaS) for electric vehicles, said method being performed on a computing device and executed by a processor, said method comprising:
initiating a battery swapping transaction in response to a request from a user, and verifying the user as a subscriber to the service;
determining the availability of charged battery packs and assigning the user to a kiosk within a network of kiosks based on user location and availability of new battery packs within the network of kiosks;
executing a receive transaction at the assigned kiosk and directing the disengagement of a battery pack from the kiosk and delivery to a receiving bay for retrieval by the user;
prompting the user to initiate a return transaction in the event the user wishes to return a used battery pack;
executing payment for the receive and/or return transaction; and
generating verification and confirmation of the transactions.

11. The BaaS method of claim 10, further comprising:
if the user initiates a return transaction, executing the return transaction and directing the placement of the used battery pack into assigned charging or parking slot in the kiosk; and
optionally initiating charging of the used battery.

12. The BaaS method of claim 10, wherein the step of executing payment further comprises, determining the amount of battery charge consumed by the user and calculating payment owed by the user based on the amount of charge consumed.

13. A battery swapping system comprising:
a non-transitory data storage device; and
one or more special purpose computer devices that implement a battery swapping service (BaaS) for electric vehicles, and employ at least one processor to perform actions, including:
initiating a battery swapping transaction in response to a request from a user, and verifying the user as a subscriber to the service;
determining the availability of charged battery packs and assigning the user to a kiosk within a network of kiosks based on user location and availability of new battery packs within the network of kiosks;
executing a receive transaction at the assigned kiosk and directing the disengagement of a battery pack from the kiosk and delivery to a receiving bay for retrieval by the user;
prompting the user to initiate a return transaction in the event the user wishes to return a used battery pack;
executing payment for the receive and/or return transaction; and
generating verification and confirmation of the transactions.

14. The system of 13, wherein the return transaction is carried out in part by assigning and directing placement of the used battery pack into assigned charging or parking slot in the kiosk;
and optionally initiating charging the used battery.

15. The system of claim 13 wherein an amount of battery charge consumed by the user is determined and payment owed by the user is based on the amount of charge consumed.

16. The system of claim 13 wherein the one or more special purpose computer devices are comprised of a data management system network, the network comprising multiple terminal devices in communication with network, and including a battery charging terminal device, a battery delivery terminal device, a battery swapping kiosks terminal device, and one or more user devices.

17. An electric vehicle, characterized in that the electric vehicle is configured to receive a swappable battery for powering of the electrical vehicle.

18. A computer implemented method for providing a battery swapping service (BaaS) for electric vehicles, said method being performed on a computing device and executed by a processor, said method comprising:
creating a user profile for a user, including a driving profile for that user;
initiating a battery swapping transaction in response to a request from a user, and verifying the user as a subscriber to the service;
determining the availability of charged battery packs and assigning the user to a swapping/charging station within a network of swapping/charging stations based on user location and availability of new battery packs within the network of stations;
allocating a particular battery pack within the assigned swapping/charging station based on the user's driving profile;
executing a receive transaction at the assigned swapping/charging station and directing the disengagement of a battery pack from the station and delivery to a receiving bay for retrieval by the user;
prompting the user to initiate a return transaction in the event the user wishes to return a used battery pack;
executing payment for the receive and/or return transaction; and
generating verification and confirmation of the transactions.

19. The BaaS method of claim 18, further comprising:
monitoring the state of a battery pack when in use by the user; and
notifying the user to return the battery pack for swapping when the state of the battery pack reaches a defined threshold.

20. The BaaS method of claim 19 wherein the defined threshold is any one or more of:
remaining charge, charge capacity, number of charging cycles, number of discharging cycles or rate of discharge.

21. A battery swapping (BaaS) system comprising:
a non-transitory data storage device; and
one or more special purpose computer devices including a central management system that implement a battery swapping service (BaaS) for electric vehicles, and employ at least one processor to perform actions, including:
initiating a battery swapping transaction in response to a request from a user or in response to a notification from the central management system, determining the availability of charged battery packs and assigning the user to a swapping/charging station or kiosk within a network of swapping/charging stations based on user location and availability of new battery packs within the network of stations;
executing a receive transaction at the assigned station and directing the disengagement of a battery pack from the station and delivery to a receiving locker for retrieval by the user;
prompting the user to initiate a return transaction in the event the user wishes to return a used battery pack;
executing payment for the receive and/or return transaction; and
generating verification and confirmation of the transactions.

22. The battery swapping system of claim 21, further comprising:
creating a user profile for a user, including a driving profile for that user; and
allocating a particular battery pack within the assigned swapping/charging station based on the user's driving profile.

23. The battery swapping system of claim 21, further comprising:
monitoring the state of a battery pack when in use by the user; and
notifying the user to return the battery pack for swapping when the state of the battery pack reaches a defined threshold, wherein the defined threshold is any one or more of: remaining charge, charge capacity, number of charging cycles, number of discharging cycles or rate of discharge.

24. The battery swapping system of claim 23, further comprising:
controlling discharging of the battery pack when in use by the user based on the state of the battery pack.

25. The battery swapping system of claim 21 further comprising:
assessing the state of the used battery pack; and
charging the used battery pack based on the state of the battery pack and in a manner to prolong operating life of the battery pack.
